(19) United States
(12) Patent Application Publication
(10) Pub. No.: US 2024/0236107 A1
(43) Pub. Date: Jul. 11, 2024

(54) CLOUD BASED APPLICATION ACCESS PRIVILEGE GOVERNANCE

(71) Applicant: Oracle International Corporation, Redwood Shores, CA (US)

(72) Inventors: Elangovan SUBRAMANIAN, Belmont, CA (US); Gaurav KUMAR, Noida (IN); Aryan Kumar SINGH, Jaipur (IN)

(21) Appl. No.: 18/150,268

(22) Filed: Jan. 5, 2023

(51) Int. Cl. H04L 9/40; G06F 18/23213

(52) U.S. Cl. CPC H04L 63/104; G06F 18/23213

(57) ABSTRACT

Embodiments provide cloud based access privilege governance. Embodiments retrieve identity access data and encode the identity access data as a plurality of binary vectors. Embodiments determine a distinct identity access count as a cluster count, normalize the cluster count, and perform peer group analysis using the normalized cluster count.

### FIELD

One embodiment is directed generally to a computer system, and in particular to a cloud based application access privilege governance system.

### BACKGROUND INFORMATION

Cloud service providers provide various services in the “cloud”, meaning over a network, such as the public Internet, that are remotely accessible to any network-connected client device. Examples of the services models used by cloud service providers (also referred to herein as “cloud providers” or “providers”) include infrastructure as a service (“IaaS”), platform as a service (“PaaS”), software as a service (“SaaS”), and network as a service (“NaaS”). IaaS providers provide customers with infrastructure resources such as processing, storage, networks, and other computing resources that the customer is able to use to run software. The customer does not manage the infrastructure, but has control over operating systems, storage, and deployed applications, among other things, and may be able to control some networking components, such as firewalls. PaaS providers provide a customer with a platform on which the customer can develop, run, and manage an application without needing to maintain the underlying computing infrastructure. SaaS is a software licensing and delivery model in which software is licensed to a customer on a subscription basis, and is centrally hosted by the cloud provider. Under this model, applications can be accessed, for example, using a web browser. NaaS providers provide network services to customers, for example, by provisioning a virtual network on the network infrastructure operated by another party. In each of these service models, the cloud service provider maintains and manages the hardware and/or software that provide the services, and little, if any, software executes on a user's device.

Customers of cloud service providers, which are also referred to herein as users and tenants, can subscribe to the service provider to obtain access to the particular services provided by the service provider. The service provider can maintain an account for a user or tenant through which the user and/or tenant can access the provider's services. The service provider can further maintain user accounts that are associated with the tenant, for individual users.

Further, in a cloud environment, resources, such as applications, can be secured and protected by an identity service provider. An identity service provider can be responsible for handling, for example, authentication, authorization, single sign-on (“SSO”), user management, application management and audit. An identity service provider can offer flexibility and standard solutions.

### SUMMARY

Embodiments provide cloud based access privilege governance. Embodiments retrieve identity access data and encode the identity access data as a plurality of binary vectors. Embodiments determine a distinct identity access count as a cluster count, normalize the cluster count, and perform peer group analysis using the normalized cluster count.

### BRIEF DESCRIPTION OF THE DRAWINGS

Further embodiments, details, advantages, and modifications will become apparent from the following detailed description of the embodiments, which is to be taken in conjunction with the accompanying drawings.

FIG. 1 illustrates an example of a system that includes an access governance system in accordance to embodiments.

FIG. 2 is a block diagram of the access governance system of FIG. 1 in the form of a computer server/system in accordance with an embodiment of the present invention.

FIG. 3 illustrates a block diagram of an example cloud infrastructure system in accordance to embodiments.

FIG. 4 illustrates an example dashboard view/screenshot in accordance to embodiments.

FIG. 5 is a flow diagram that illustrates the functionality of the access governance module of FIG. 1 in accordance to embodiments.

FIGS. 6-9 illustrate an example cloud infrastructure that can incorporate the secure on-premises to cloud connector framework system in accordance to embodiments.

### DETAILED DESCRIPTION

One embodiment performs access governance by reviewing user entitlements and access privileges using machine learning clustering for peer group analysis in order to determine outliers. Embodiments automatically and dynamically determine the number of cluster counts that are used for the clustering.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

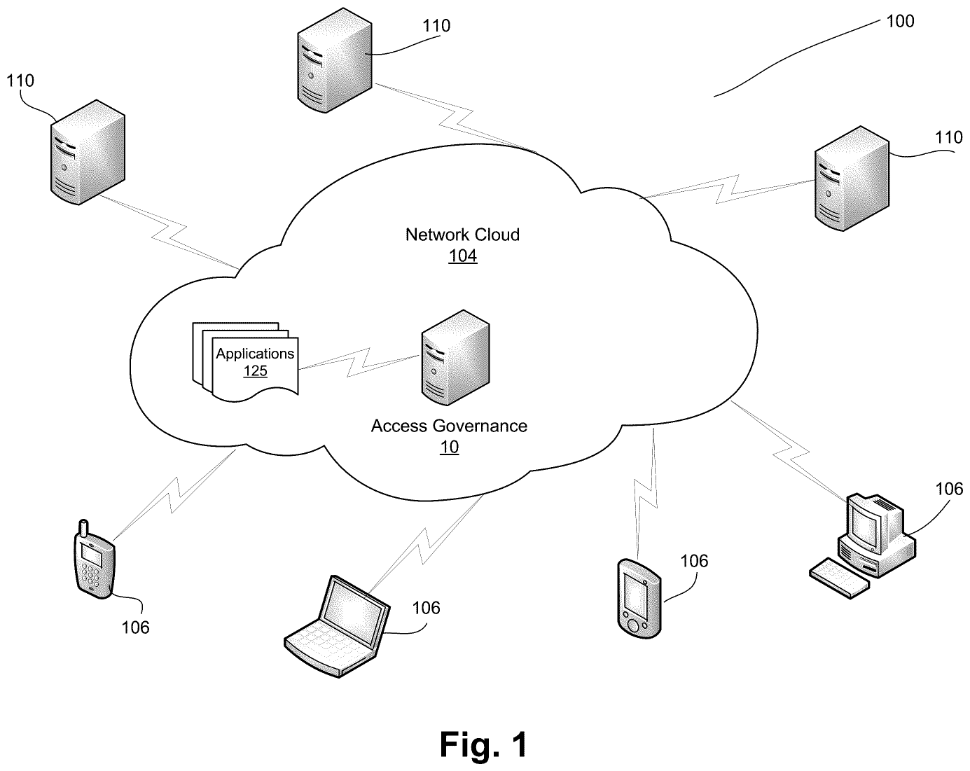

FIG. 1 illustrates an example of a system 100 that includes an access governance system 10 in accordance to embodiments. Access governance system 10 may be implemented within a computing environment that includes a communication network/cloud 104. Network 104 may be a private network that can communicate with a public network (e.g., the Internet) to access additional services 110 provided by a cloud services provider (i.e., a cloud infrastructure). Examples of communication networks include a mobile network, a wireless network, a cellular network, a local area network (“LAN”), a wide area network (“WAN”), other wireless communication networks, or combinations of these and other networks. Access governance system 10 may be administered by a service provider, such as via the Oracle Cloud Infrastructure (“OCI”) from Oracle Corp.

Tenants of the cloud services provider can be organizations or groups whose members include users of services offered by service provider. Services may include or be provided as access to, without limitation, an application, a resource, a file, a document, data, media, or combinations thereof. Users may have individual accounts with the service provider and organizations may have enterprise accounts with the service provider, where an enterprise account encompasses or aggregates a number of individual user accounts.

System 100 further includes client devices 106, which can be any type of device that can access network 104 and can obtain the benefits of the functionality of access governance system 10 of governing access to applications. As disclosed herein, a “client” (also disclosed as a “client system” or a “client device”) may be a device or an application executing on a device. System 100 includes a number of different types of client devices 106 that each is able to communicate with network 104.

Executing on cloud 104 are one or more applications 125 for which access governance system 10 governs/restricts access. Access governance system 10, in general, provides one or more of the visibility of enterprise compliance by providing details on who has access to what, an ability for reviewers to optimize user privileges through intelligent access review campaigns, and actionable identity intelligence by building deep insights into potential security violations that enable rapid remediation of identity and access challenges.

In embodiments, access governance system 10 provides an “access review”, which is a review of access and permissions for an entity, usually an end user, that is carried out to confirm whether the access and permissions assigned to that entity are still valid. An example use case may be when an end user moves to another department within an organization and as a result no longer requires access to a particular resource. Access reviews can run on-demand or can be scheduled periodically, or can be event based when one or more predefined event types occur. These access reviews will review user access assignments where individual access to a specific source is checked and either certified or remediated.

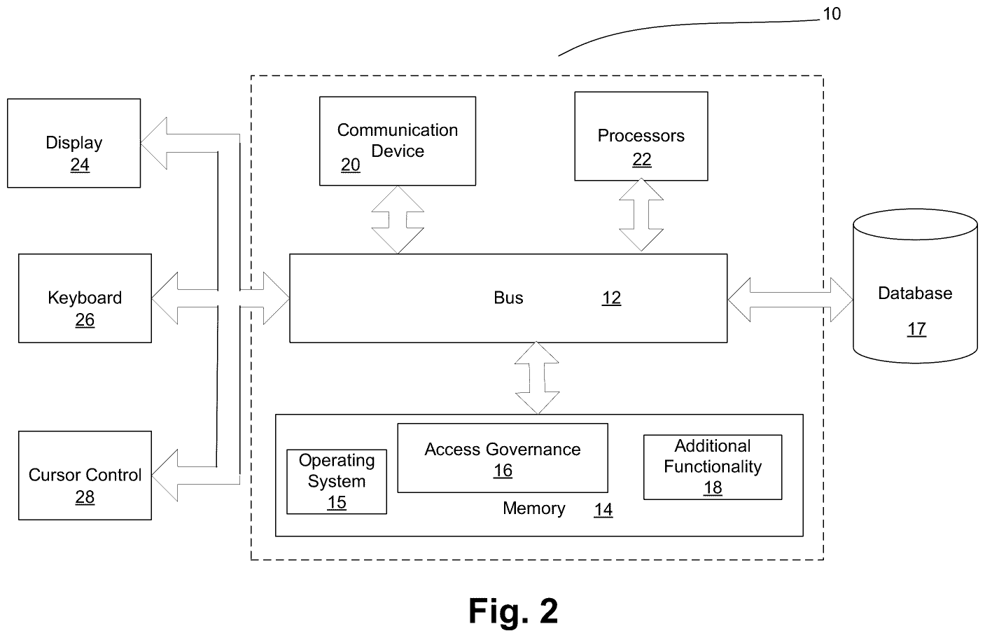

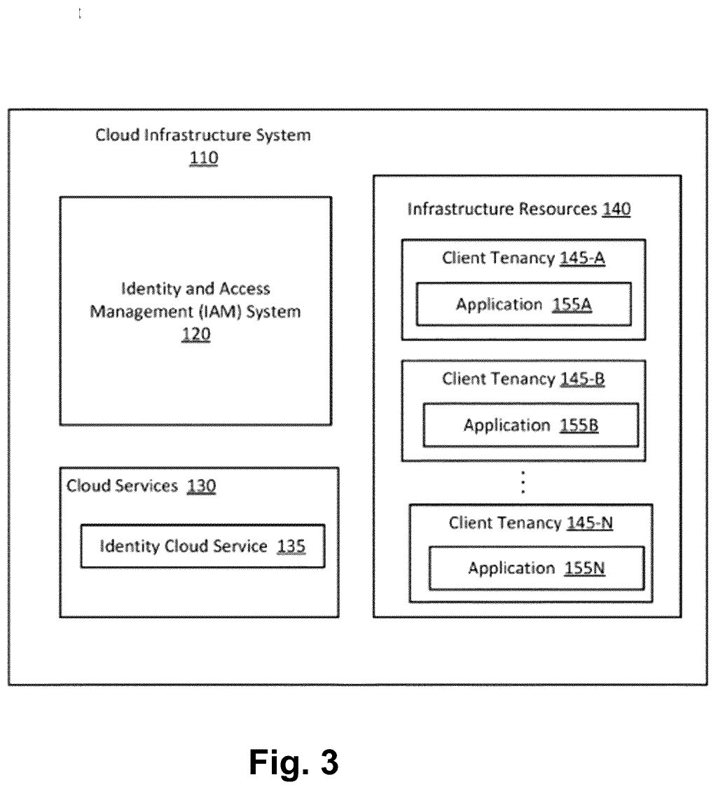

FIG. 2 is a block diagram of access governance system 10 of FIG. 1 in the form of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. One or more components of FIG. 2 can also be used to implement any of the elements of FIG. 1 and FIG. 3, discussed below.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include an access governance module 16 that provides access governance, and all other functionality disclosed herein. System 10 can be part of a larger system. Therefore, system 10 can include one or more additional functional modules 18 to include the additional functionality, such as any other functionality provided by the Oracle Cloud Infrastructure (“OCI”) from Oracle Corp. A file storage device or database 17 is coupled to bus 12 to provide centralized storage for modules 16 and 18, including data regarding previous schema mappings. In one embodiment, database 17 is a relational database management system (“RDBMS”) that can use Structured Query Language (“SQL”) to manage the stored data.

FIG. 3 illustrates a block diagram of an example cloud infrastructure system 110 in accordance to embodiments. In one embodiment, cloud infrastructure system 110 implements network cloud 104 of FIG. 1. In one embodiment, cloud infrastructure system 110 is operated by a cloud service provider.

Cloud infrastructure system 110 may include infrastructure resources 140 (e.g., hardware and/or software components configurable to provide cloud services 130 to clients of the cloud infrastructure system 110). As illustrated, the infrastructure resources can be partitioned into different client tenancies 145A-145N. Each client tenancy 145A-145N is a logical container that can contain logical resources to which the corresponding client (e.g., customer or user) has secure and private access. For example a logical resource could be a database, a load balancer, or a testing platform for testing software code.

As illustrated in FIG. 3, cloud infrastructure system 110 may include an Identity Access Management (“IAM”) system 120, which can also be known as an Access Management System (“AMS”), identity system, or cloud identity system. In embodiments, the access governance functionality discloses herein is part of IAM system 120.

IAM system 120 may be configured to manage access to the infrastructure resources 140 by user principals and/or resource principals. For example, the functionality provided by IAM system 120 may include an identity cloud service 135 (another example of cloud services 130). The cloud based identity service (e.g., identity cloud service 135) can be configured to maintain stored information about users associated with tenancies 145A-145N, such as usernames, passwords or other credential information, user information, and the like. IAM system 120 can be implemented in hardware and/or software and may include, for example, one or more access management servers configured to process requests from client devices for access to resources within client tenancies 145A-145N.

IAM system 120 is configured to protect access to protected resources, such as applications 125. Each of client tenancies 145A-145N can include one or more applications 155A-155N (e.g., applications 125 of FIG. 1). Applications 155A-155N can correspond to business applications that are used by the client, such as human resource applications, payment applications, etc. Each of the tenants client tenancies 145A-145N can include a plurality of different applications based on their business needs. Further, each of the applications can be configured to include different authentication processes and can be configured to provide different information during the authentication process.

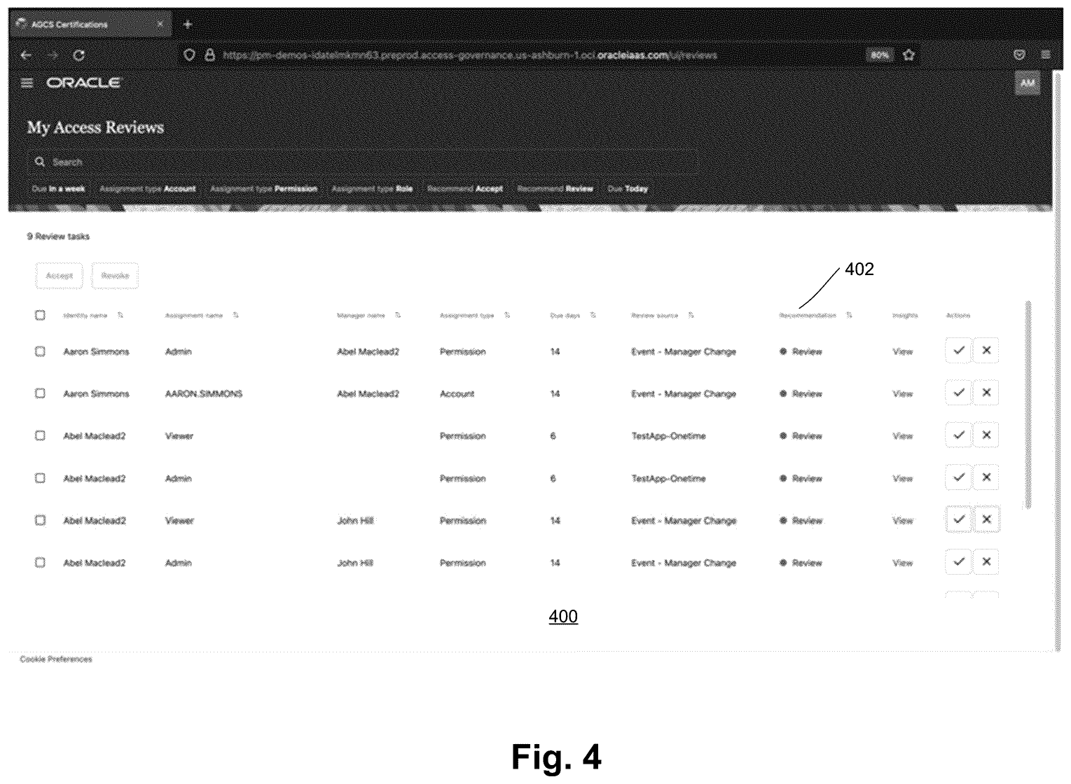

As disclosed, embodiments implement access governance, including identity certification. Identity certification is the process of reviewing user entitlements and access-privileges within an enterprise to ensure that users have not acquired entitlements that they are not authorized to have. Embodiments include on-demand access reviews where access reviewers can review user permissions and roles in a single dashboard view. FIG. 4 illustrates an example dashboard view/screenshot 400 in accordance to embodiments. Dashboard 400 provides a list of user permissions that are recommended to be reviewed at column 402 due to the detection of possible identity issues/anomalies.

Access governance in accordance to embodiments can highlight risky entitlements and recommend remediation to help reviewers make informed decisions to revoke or accept each user's access. Each type of reviewer reviews a different subset of access-related data from a specific point of view. Embodiments implement peer group analysis which compares the target access profile with the other access profile which is identified as similar to the target access profile in some sense (i.e., peer group). The peer group analysis results in a determination of access profile anomalies. A peer group is considered a grouping of users that perform similar job functions.

In embodiments, peer group analysis (“PGA”) is the analysis technique which compares the target access profile with the other access profile which is identified as similar to the target access profile in some sense (i.e., peer group). A user's access profile is created based on the behavior of some similar users where current outlier detection techniques over time include profiling for a single user. PGA considers local patterns in the data rather than global patterns; a data sequence may not give results unusually when it is compared with the complete data set of sequences but it shows unusual properties when compared with its peer group. That is, it may begin to deviate in behavior from objects to which it has previously been similar. PGA is a technique which has been developed to describe the analysis of the time development of a given data (the target) relative to other objects data that have been identified as similar initially. The PGA approach is different. The profile of user is formed based on the behavior of several similar users.

In embodiments, the peer group analysis is implemented using an unsupervised machine learning clustering algorithm to cluster the selected identity and access data in the access review. Clustering is a form of data mining in which a set of objects (i.e., the identity and access data) are grouped in such a way that objects in the same group (the cluster) are more similar in some sense to each other than to those in other groups (clusters). In one embodiment, the “k-means” clustering algorithm is used. K-means clustering aims to partition n observations into k clusters in which each observation belongs to the cluster with the nearest mean, serving as a prototype of the cluster. However, other clustering algorithms such as hierarchical clustering, etc., can also be used.

In one embodiment, the following k-means clustering algorithm is used: Given an initial set of k means m₁⁽¹⁾, . . . ,mₖ⁽¹⁾, the algorithm proceeds by alternating between two steps:
(1) Assignment step: Assign each observation to the cluster with the nearest mean: that with the least squared Euclidean distance. (Mathematically, this means partitioning the observations according to the Voronoi diagram generated by the means.)

$${S}_{i}^{( t )} = \{ {x}_{p} : {‖ {x}_{p} - {m}_{i}^{( t )} ‖}^{2} \leq {‖ {x}_{p} - {m}_{j}^{( t )} ‖}^{2} ∀ j , 1 \leq j \leq k \} ,$$

where each xₚ is assigned to exactly one S^{(t)}, even if it could be assigned to two or more of them.
(2) Update step: Recalculate means (centroids) for observations assigned to each cluster.

$${m}_{i}^{( t + 1 )} = \frac{1}{\vert {S}_{i}^{( t )} \vert} {\sum }_{{x}_{j} ∈ {S}_{i}^{( t )}} {x}_{j}$$

The algorithm has converged when the assignments no longer change.

Based on the k-means cluster result, risk insights for the given user entitlements and access privileges are identified and help the access reviewers to take appropriate action via an “access review task.”

However, the k-means clustering algorithm requires a pre-defined number of cluster values (i.e., the “k” value) as a pre-requisite. An accurate number of cluster values needs to be identified/determined based on the selected identity and access data in the access review. In embodiments, because the volume of the selected identity and access data can be in the range of 100,000 entries and it varies between various access review campaigns, embodiments require a reliable and performant solution to determine the number of clusters.

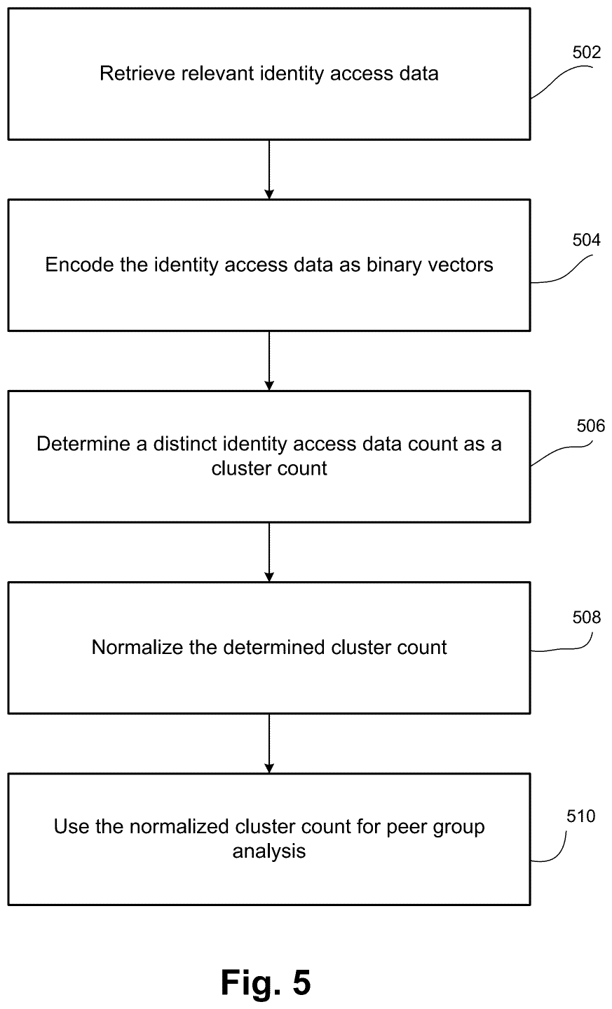

FIG. 5 is a flow diagram that illustrates the functionality of access governance module 16 of FIG. 1 in accordance to embodiments. In one embodiment, the functionality of the flow diagram of FIG. 5 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 502, relevant identity access data is received/retrieved. In embodiments, the data is received from various target systems such as Active Directory, E-Business Suite, etc. In embodiments, the identity access data includes, for each identity (i.e., user), a listing of applications that the user has access to and the corresponding permission level for that application. Table 1 below provides a simplified example of access data for four uses/identities and four different applications (i.e., “E-Business”, “Confluence”, “Corporate LDAP Server” and “Sales Portal”). However, in a typical enterprise environment, the access data may include, for example, 3 to 5 million users accessing 2000 to 3000 different applications.

TABLE 1

| | Access Data (Application and Permission identity have access |
|---|---|
| Identity | to) |
| Joe | E-Business - Administrator, Confluence - Content Developer, |
| | Corporate LDAP Server - Read Only User |
| Smith | E-Business - Expense Viewer, Confluence - Content Developer |
| Aryan | Sales Portal - Agent, Viewer, Corporate LDAP Server - Read |
| | Only User |
| Alice | E-Business - Expense Viewer, Confluence - Content Developer |

At 504, embodiments encode the identity access data as binary vectors. For each identity, and for each possible combination of application/permission identity, the vector equals a “1” if the combination is present for that identity, and a “0” if the combination is not present for that identity. Table 2 below are example binary vectors corresponding to the example of Table 1.

TABLE 2

| | | Confluence - | Corporate LDAP | E-Business - | Sales | Sales |
|---|---|---|---|---|---|---|
| | E-Business - | Content | Server - Read | Expense | Portal - | Portal - |
| Identity | Administrator | Developer | Only User | Viewer | Agent | Viewer |
| Joe | 1 | 1 | 1 | 0 | 0 | 0 |
| Smith | 0 | 1 | 0 | 1 | 0 | 0 |
| Aryan | 0 | 0 | 1 | 0 | 1 | 1 |
| Alice | 0 | 1 | 0 | 1 | 0 | 0 |

At 506, embodiments use the above vectors to determine a distinct identity access data count. Embodiments, using the above one hot encoded selected identity access data binary vector, determine the distinct identity access data count using a min-wise independent permutations locality sensitive hashing scheme (“Minhash”) and a locality-sensitive hashing algorithm. MinHash is a technique for quickly estimating how similar two sets are and is an instance of locality sensitive hashing (LSH)

LSH involves generating a hash code such that similar items will tend to get similar hash codes. LSH allows a hash code to be precomputed that is then quickly and easily compared to another precomputed LSH hash code to determine if two objects should be compared in more detail or quickly discarded. A collection of Minhash values is categorized into bands and rows. For the sake of simplicity, assume each user has 16 Minhash values based on their entitlement assignments. Embodiments break them down into 4 bands with 4 rows each. Also, for the sake of simplicity, assume that hash value results in a number between 0 and 9. Therefore, conceptually, the Minhash values from 4 users in the first of the 4 bands and its rows is as follows:

| | | MinHash | MinHash | MinHash | MinHash |
|---|---|---|---|---|---|
| | | value using | value using | value using | value using |
| | | hash | hash | hash | hash |
| Band | User | function f1 | function f2 | function f3 | function f4 |
| 1 | Smith | 1 | 3 | 6 | 0 |
| | Joe | 2 | 3 | 1 | 0 |
| | Alice | 1 | 3 | 6 | 0 |
| | Aryan | 2 | 1 | 3 | 1 |

Where the hash function used for each bucket hash value (i.e., column in the table) is as follows:
F=(a*x+b) % LARGE_PRIME
a->Randomly generated between [1 to LARGE_PRIME−1]
b->Randomly generated between [1 to LARGE_PRIME−1]
x->Integer value generated based on entitlement assignments
LARGE_PRIME=2147483647=2\hat{ }31−1

Embodiments look for rows within a band that are the same between users. User “Smith” and user “Alice” in this case both have rows with values 1, 3, 6, 0. This indicates that these two users should be compared for their similarity. Although it is not shown here, embodiments look through Bands Two through Five looking for users that share rows. Any users that share rows in any bands should be compared for their similarity.

Using the example of Table 2 above, embodiments would determine the count of distinct sets of identity access data equals 3. Since user “Smith” and “Alice” has similar access profile, embodiments arrive at 3 as distinct sets for identity access data count (e.g., “Joe” forms one set, “Smith and Alice” form one set, and “Aryan” forms a third set).

At 508, embodiments normalize the cluster count determined at 506 to determine a normalized cluster count. Depending on the size of the selected identity access data and its access profile similarity, the distinct identity access data count can vary from 1 to N. Access profile similarity is how similar entitlement assignments are between the selected users. Based on the similarity count, embodiments need to normalize the number of clusters using the below. N could be very large or very low based on the distribution of the access profile data. In one embodiment, Table 3 below dictates how to determine the optimal number of cluster value from the distinct identity access data count.

| Distinct Identity access | |
|---|---|
| data count | Number of Cluster |
| Between 1 and 9 | Distinct Identity access data count |
| Between 10 and 49 | Distinct Identity access data count * 0.9 |
| Between 50 and 99 | Distinct Identity access data count * 0.5 |
| 100 and above | 50 |

In other embodiments, a range of cluster numbers can be used instead of a fixed multiplier. For example, in embodiments, for the access count between 10 and 49, the normalized access count used is 85%-90% of the original access count. Similarly, in embodiments, for the access count between 50 and 99, the normalized access count used is 45%-50% of the original access count. The normalization, which generally reduces the originally determined access count, is done to keep the cluster count manageable to avoid performance issues. The normalization in accordance to embodiments provides unexpected results as performance improves while the accuracy remains the same or nearly the same as using non-normalized, much higher, cluster counts.

At 510, the normalized cluster count determined at 508 is then used in the peer group analysis using k-means clustering in order to derive insights and recommendations and determine anomalies such as a user maintaining entitlements or access privileges that they are no entitle to. These anomalies can be displayed in the form of a dashboard or other type of user interface. Further, automatic actions can be taken, such as a user having access to an application being automatically revoked.

As disclosed, embodiments determine the number of clusters based on selected very large identity and access data in a performant and optimal manner. Embodiments, based on empirical analysis done on various customer simulation environment data, determines the normalized number of cluster value from the identified distinct identity access data count.

### Example Cloud Infrastructure

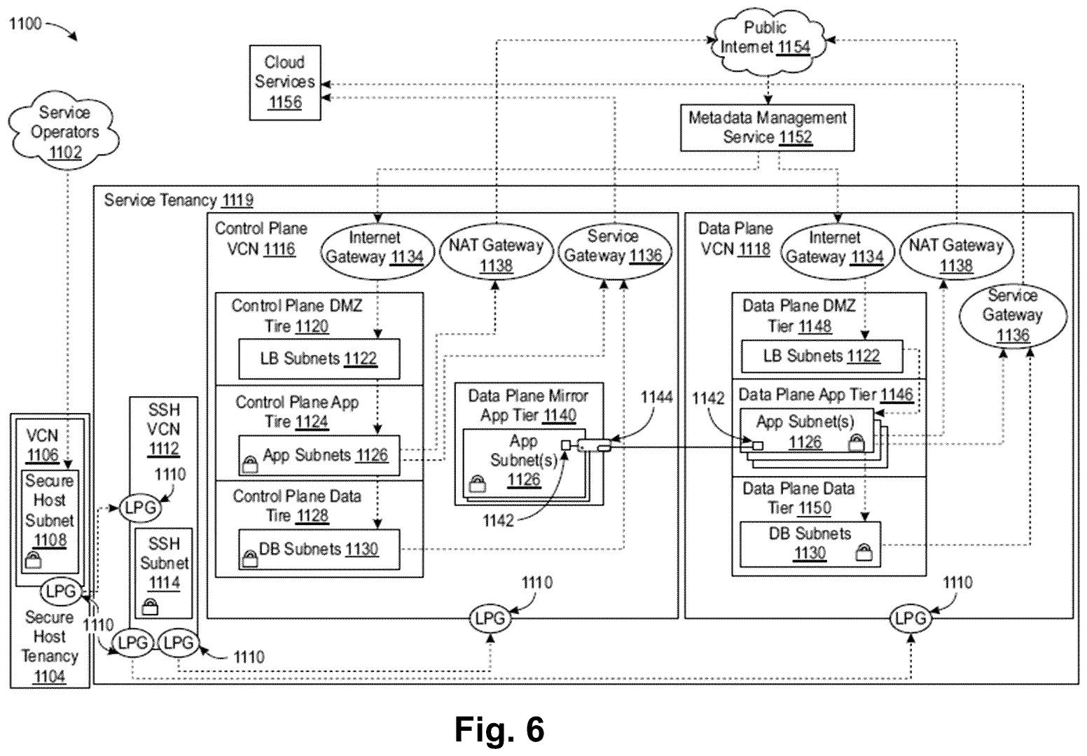

FIGS. 6-9 illustrate an example cloud infrastructure that can incorporate the secure on-premises to cloud connector framework system in accordance to embodiments. The cloud infrastructure of FIG. 6-9 can be used to implement network/cloud 104 of FIG. 1 and host access governance system 10.

As disclosed above, infrastructure as a service (“IaaS”) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance.

In some instances, IaaS customers may access resources and services through a wide area network (“WAN”), such as the Internet, and can use the cloud provider's services to install the remaining elements of an application stack. For example, the user can log in to the IaaS platform to create virtual machines (“VM”s), install operating systems (“OS”s) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different problems for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (“VPC”s) (e.g., a potentially on-demand pool of configurable and/or shared computing resources), also known as a core network. In some examples, there may also be one or more security group rules provisioned to define how the security of the network will be set up and one or more virtual machines. Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 6 is a block diagram 1100 illustrating an example pattern of an IaaS architecture, according to at least one embodiment. Service operators 1102 can be communicatively coupled to a secure host tenancy 1104 that can include a virtual cloud network (“VCN”) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (“PDA”)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (“SMS”), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (“LPG”) 1110 that can be communicatively coupled to a secure shell (“SSH”) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (“DMZ”) tier 1120 that acts as a perimeter network (e.g., portions of a corporate network between the corporate intranet and external networks). The DMZ-based servers may have restricted responsibilities and help keep security breaches contained. Additionally, the DMZ tier 1120 can include one or more load balancer (“LB”) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (“API”) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (“CRUD”) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Memory that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of security, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

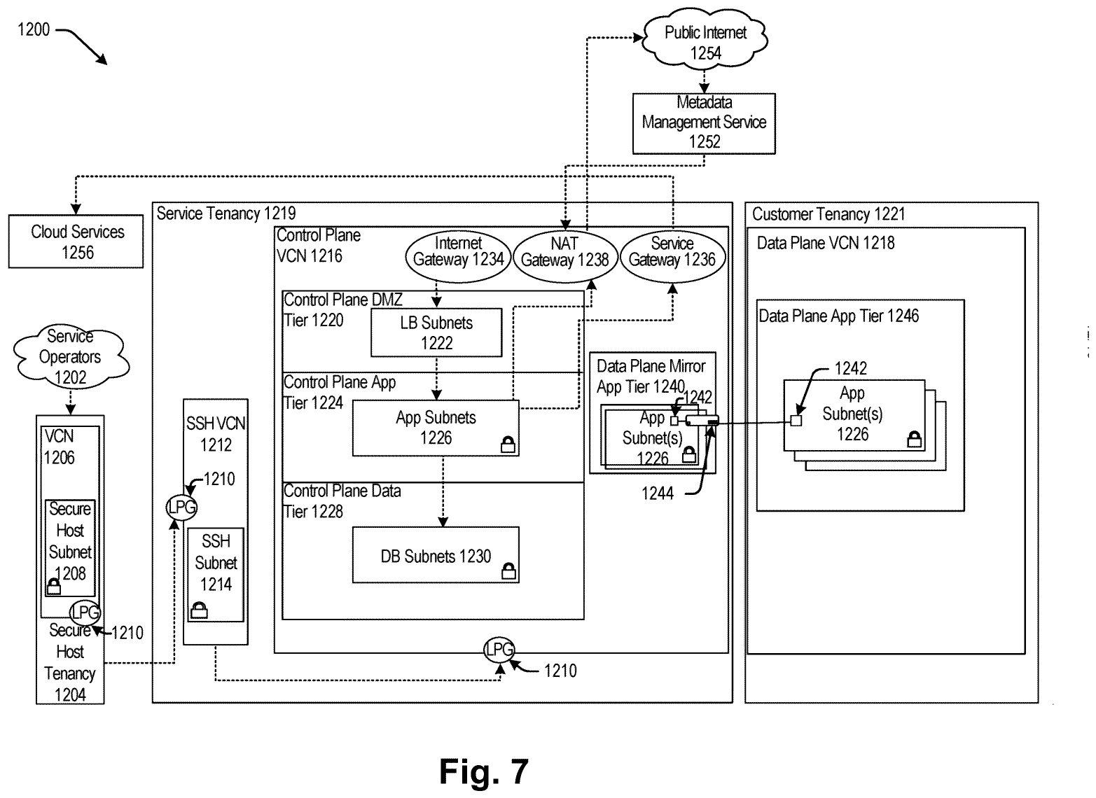

FIG. 7 is a block diagram 1200 illustrating another example pattern of an IaaS architecture, according to at least one embodiment. Service operators 1202 (e.g. service operators 1102) can be communicatively coupled to a secure host tenancy 1204 (e.g. the secure host tenancy 1104) that can include a virtual cloud network (VCN) 1206 (e.g. the VCN 1106) and a secure host subnet 1208 (e.g. the secure host subnet 1108). The VCN 1206 can include a local peering gateway (LPG) 1210 (e.g. the LPG 1110) that can be communicatively coupled to a secure shell (SSH) VCN 1212 (e.g. the SSH VCN 1112 10) via an LPG 1110 contained in the SSH VCN 1212. The SSH VCN 1212 can include an SSH subnet 1214 (e.g. the SSH subnet 1114), and the SSH VCN 1212 can be communicatively coupled to a control plane VCN 1216 (e.g. the control plane VCN 1116) via an LPG 1210 contained in the control plane VCN 1216. The control plane VCN 1216 can be contained in a service tenancy 1219 (e.g. the service tenancy 1119), and the data plane VCN 1218 (e.g. the data plane VCN 1118) can be contained in a customer tenancy 1221 that may be owned or operated by users, or customers, of the system.

The control plane VCN 1216 can include a control plane DMZ tier 1220 (e.g. the control plane DMZ tier 1120) that can include LB subnet(s) 1222 (e.g. LB subnet(s) 1122), a control plane app tier 1224 (e.g. the control plane app tier 1124) that can include app subnet(s) 1226 (e.g. app subnet(s) 1126), a control plane data tier 1228 (e.g. the control plane data tier 1128) that can include database (DB) subnet(s) 1230 (e.g. similar to DB subnet(s) 1130). The LB subnet(s) 1222 contained in the control plane DMZ tier 1220 can be communicatively coupled to the app subnet(s) 1226 contained in the control plane app tier 1224 and an Internet gateway 1234 (e.g. the Internet gateway 1134) that can be contained in the control plane VCN 1216, and the app subnet(s) 1226 can be communicatively coupled to the DB subnet(s) 1230 contained in the control plane data tier 1228 and a service gateway 1236 and a network address translation (NAT) gateway 1238 (e.g. the NAT gateway 1138). The control plane VCN 1216 can include the service gateway 1236 and the NAT gateway 1238.

The control plane VCN 1216 can include a data plane mirror app tier 1240 (e.g. the data plane mirror app tier 1140) that can include app subnet(s) 1226. The app subnet(s) 1226 contained in the data plane mirror app tier 1240 can include a virtual network interface controller (VNIC) 1242 (e.g. the VNIC of 1142) that can execute a compute instance 1244 (e.g. similar to the compute instance 1144). The compute instance 1244 can facilitate communication between the app subnet(s) 1226 of the data plane mirror app tier 1240 and the app subnet(s) 1226 that can be contained in a data plane app tier 1246 (e.g. the data plane app tier 1146) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g. the metadata management service 1152) that can be communicatively coupled to public Internet 1254 (e.g. public Internet 1154). Public Internet 1254 can be communicatively coupled to the NAT gateway 1238 contained in the control plane VCN 1216. The service gateway 1236 contained in the control plane VCN 1216 can be communicatively couple to cloud services 1256 (e.g. cloud services 1156).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218, but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 8,” may be located in Region 1 and in “Region 2.” If a call to Deployment 8 is made by the service gateway 1236 contained in the control plane VCN 1216 located in Region 1, the call may be transmitted to Deployment 8 in Region 1. In this example, the control plane VCN 1216, or Deployment 8 in Region 1, may not be communicatively coupled to, or otherwise in communication with, Deployment 8 in Region 2.

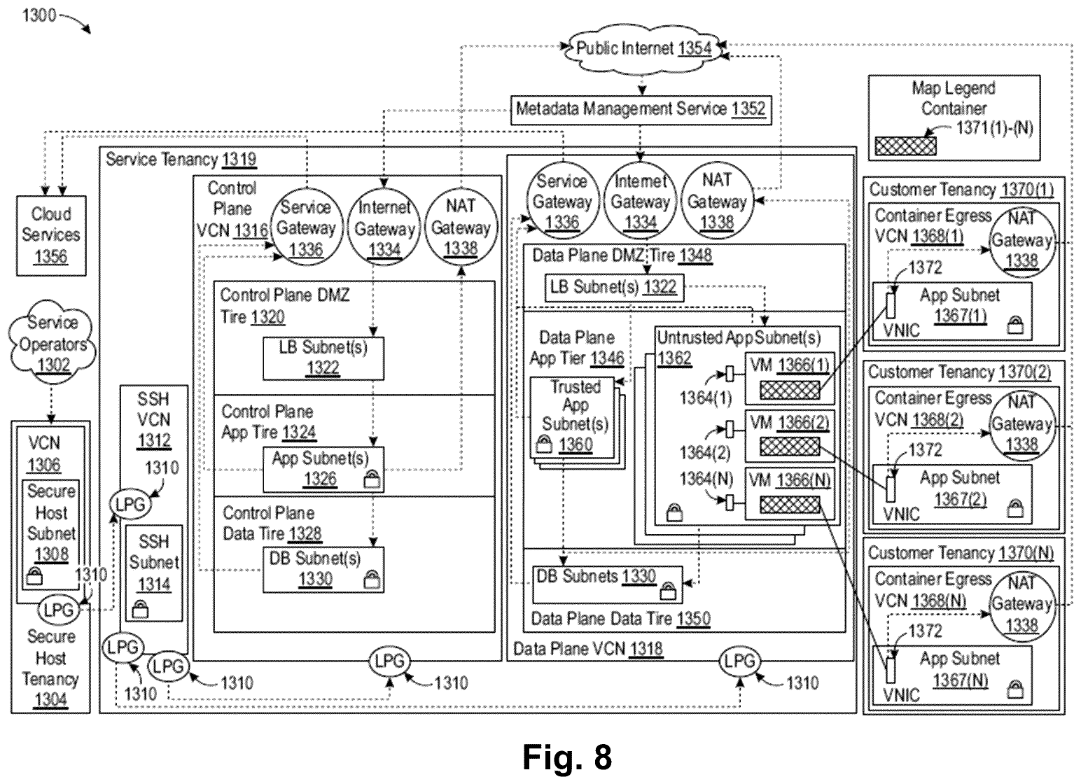

FIG. 8 is a block diagram 1300 illustrating another example pattern of an IaaS architecture, according to at least one embodiment. Service operators 1302 (e.g. service operators 1102) can be communicatively coupled to a secure host tenancy 1304 (e.g. the secure host tenancy 1104) that can include a virtual cloud network (VCN) 1306 (e.g. the VCN 1106) and a secure host subnet 1308 (e.g. the secure host subnet 1108). The VCN 1306 can include an LPG 1310 (e.g. the LPG 1110) that can be communicatively coupled to an SSH VCN 1312 (e.g. the SSH VCN 1112) via an LPG 1310 contained in the SSH VCN 1312. The SSH VCN 1312 can include an SSH subnet 1314 (e.g. the SSH subnet 1114), and the SSH VCN 1312 can be communicatively coupled to a control plane VCN 1316 (e.g. the control plane VCN 1116) via an LPG 1310 contained in the control plane VCN 1316 and to a data plane VCN 1318 (e.g. the data plane 1118) via an LPG 1310 contained in the data plane VCN 1318. The control plane VCN 1316 and the data plane VCN 1318 can be contained in a service tenancy 1319 (e.g. the service tenancy 1119).

The control plane VCN 1316 can include a control plane DMZ tier 1320 (e.g. the control plane DMZ tier 1120) that can include load balancer (“LB”) subnet(s) 1322 (e.g. LB subnet(s) 1122), a control plane app tier 1324 (e.g. the control plane app tier 1124) that can include app subnet(s) 1326 (e.g. similar to app subnet(s) 1126), a control plane data tier 1328 (e.g. the control plane data tier 1128) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g. the Internet gateway 1134) that can be contained in the control plane VCN 1316, and the app subnet(s) 1326 can be communicatively coupled to the DB subnet(s) 1330 contained in the control plane data tier 1328 and to a service gateway 1336 (e.g. the service gateway) and a network address translation (NAT) gateway 1338 (e.g. the NAT gateway 1138). The control plane VCN 1316 can include the service gateway 1336 and the NAT gateway 1338.

The data plane VCN 1318 can include a data plane app tier 1346 (e.g. the data plane app tier 1146), a data plane DMZ tier 1348 (e.g. the data plane DMZ tier 1148), and a data plane data tier 1350 (e.g. the data plane data tier 1150 of FIG. 11). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g. public Internet 1154).

The Internet gateway 1334 contained in the control plane VCN 1316 and contained in the data plane VCN 1318 can be communicatively coupled to a metadata management service 1352 (e.g. the metadata management system 1152) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively couple to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

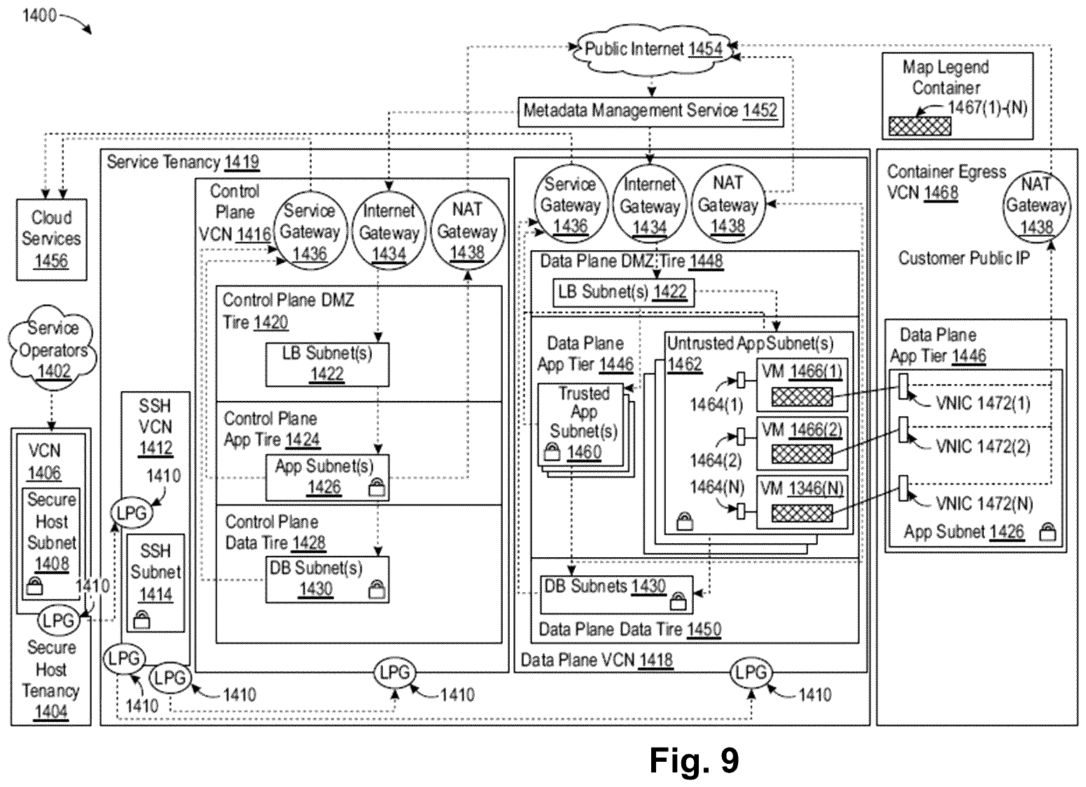

FIG. 9 is a block diagram 1400 illustrating another example pattern of an IaaS architecture, according to at least one embodiment. Service operators 1402 (e.g. service operators 1102) can be communicatively coupled to a secure host tenancy 1404 (e.g. the secure host tenancy 1104) that can include a virtual cloud network (“VCN”) 1406 (e.g. the VCN 1106) and a secure host subnet 1408 (e.g. the secure host subnet 1108). The VCN 1406 can include an LPG 1410 (e.g. the LPG 1110) that can be communicatively coupled to an SSH VCN 1412 (e.g. the SSH VCN 1112) via an LPG 1410 contained in the SSH VCN 1412. The SSH VCN 1412 can include an SSH subnet 1414 (e.g. the SSH subnet 1114), and the SSH VCN 1412 can be communicatively coupled to a control plane VCN 1416 (e.g. the control plane VCN 1116) via an LPG 1410 contained in the control plane VCN 1416 and to a data plane VCN 1418 (e.g. the data plane 1118) via an LPG 1410 contained in the data plane VCN 1418. The control plane VCN 1416 and the data plane VCN 1418 can be contained in a service tenancy 1419 (e.g. the service tenancy 1119).

The control plane VCN 1416 can include a control plane DMZ tier 1420 (e.g. the control plane DMZ tier 1120) that can include LB subnet(s) 1422 (e.g. LB subnet(s) 1122), a control plane app tier 1424 (e.g. the control plane app tier 1124) that can include app subnet(s) 1426 (e.g. app subnet(s) 1126), a control plane data tier 1428 (e.g. the control plane data tier 1128) that can include DB subnet(s) 1430 (e.g. DB subnet(s) 1330). The LB subnet(s) 1422 contained in the control plane DMZ tier 1420 can be communicatively coupled to the app subnet(s) 1426 contained in the control plane app tier 1424 and to an Internet gateway 1434 (e.g. the Internet gateway 1134) that can be contained in the control plane VCN 1416, and the app subnet(s) 1426 can be communicatively coupled to the DB subnet(s) 1430 contained in the control plane data tier 1428 and to a service gateway 1436 (e.g. the service gateway of FIG. 11) and a network address translation (NAT) gateway 1438 (e.g. the NAT gateway 1138 of FIG. 11). The control plane VCN 1416 can include the service gateway 1436 and the NAT gateway 1438.

The data plane VCN 1418 can include a data plane app tier 1446 (e.g. the data plane app tier 1146), a data plane DMZ tier 1448 (e.g. the data plane DMZ tier 1148), and a data plane data tier 1450 (e.g. the data plane data tier 1150). The data plane DMZ tier 1448 can include LB subnet(s) 1422 that can be communicatively coupled to trusted app subnet(s) 1460 (e.g. trusted app subnet(s) 1360) and untrusted app subnet(s) 1462 (e.g. untrusted app subnet(s) 1362) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g. public Internet 1154).

The Internet gateway 1434 contained in the control plane VCN 1416 and contained in the data plane VCN 1418 can be communicatively coupled to a metadata management service 1452 (e.g. the metadata management system 1152) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively couple to cloud services 1456.

In some examples, the pattern illustrated by the architecture of block diagram 1400 of FIG. 9 may be considered an exception to the pattern illustrated by the architecture of block diagram 1300 of FIG. 8 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate certain embodiments. In some other embodiments, the IaaS systems may have more or fewer components than shown in the figures, may combine two or more components, or may have a different configuration or arrangement of components.

As disclosed, embodiments determine the number of clusters based on selected very large identity and access data in a performant and optimal manner. Embodiments determine the normalized number of cluster value from the identified distinct identity access data count.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

What is claimed is:

1. A method of access privilege governance comprising:
retrieving identity access data;
encoding the identity access data as a plurality of binary vectors;
determining a distinct identity access count as a cluster count;
normalizing the cluster count; and
performing peer group analysis using the normalized cluster count.

2. The method of claim 1, the performing peer group analysis comprising clustering the identity access data using the normalized cluster count.

3. The method of claim 2, wherein the clustering comprises k-means clustering, and the normalized cluster count comprises a k value.

4. The method of claim 1, wherein the determining the distinct identity access count as the cluster count comprises using min-wise independent permutations locality sensitive hashing scheme and a locality-sensitive hashing.

5. The method of claim 1, wherein the normalizing the cluster count comprises:
when the distinct identity access count is greater than 100, the normalized cluster count is 50, and when the distinct identity access count is between 50 and 99, the normalized cluster count is 45%-50% of the distinct identity access count.

6. The method of claim 1, wherein the normalizing the cluster count comprises:
when the distinct identity access count is between 1 and 9, the normalized cluster count is the distinct identity access count, and when the distinct identity access count is between 10 and 49, the normalized cluster count is 85%-90% of the distinct identity access count.

7. The method of claim 1, wherein the identity access data comprises a plurality of identities, and for each of the identities, a listing of applications that the identity has access to and a corresponding permission level for that application.

8. The method of claim 1, wherein the encoding the identity access data as the plurality of binary vectors comprises, for each identity, and for each possible combination of application/permission identity, a vector equals a 1 if the combination is present for that identity, and a 0 if the combination is not present for that identity.

9. A computer readable medium having instructions stored thereon that, when executed by one or more processors, cause the processors to provide cloud based access privilege governance, the governance comprising:
retrieving identity access data;
encoding the identity access data as a plurality of binary vectors;
determining a distinct identity access count as a cluster count;
normalizing the cluster count; and
performing peer group analysis using the normalized cluster count.

10. The computer readable medium of claim 9, the performing peer group analysis comprising clustering the identity access data using the normalized cluster count.

11. The computer readable medium of claim 10, wherein the clustering comprises k-means clustering, and the normalized cluster count comprises a k value.

12. The computer readable medium of claim 9, wherein the determining the distinct identity access count as the cluster count comprises using min-wise independent permutations locality sensitive hashing scheme and a locality-sensitive hashing.

13. The computer readable medium of claim 9, wherein the normalizing the cluster count comprises:
when the distinct identity access count is greater than 100, the normalized cluster count is 50, and when the distinct identity access count is between 50 and 99, the normalized cluster count is 45%-50% of the distinct identity access count.

14. The computer readable medium of claim 9, wherein the normalizing the cluster count comprises:
when the distinct identity access count is between 1 and 9, the normalized cluster count is the distinct identity access count, and when the distinct identity access count is between 10 and 49, the normalized cluster count is 85%-90% of the distinct identity access count.

15. The computer readable medium of claim 9, wherein the identity access data comprises a plurality of identities, and for each of the identities, a listing of applications that the identity has access to and a corresponding permission level for that application.

16. The computer readable medium of claim 9, wherein the encoding the identity access data as the plurality of binary vectors comprises, for each identity, and for each possible combination of application/permission identity, a vector equals a 1 if the combination is present for that identity, and a 0 if the combination is not present for that identity.

17. A cloud infrastructure comprising:
a database storing identity access data for a plurality of identities and a plurality of applications;
an access privilege governance server coupled to the database, the access privilege governance server determining access profile anomalies comprising:
encoding the identity access data as a plurality of binary vectors;
determining a distinct identity access count as a cluster count;
normalizing the cluster count; and
performing peer group analysis using the normalized cluster count.

18. The cloud infrastructure of claim 17, the performing peer group analysis comprising clustering the identity access data using the normalized cluster count.

19. The cloud infrastructure of claim 18, wherein the clustering comprises k-means clustering, and the normalized cluster count comprises a k value.

20. The cloud infrastructure of claim 17, wherein the determining the distinct identity access count as the cluster count comprises using min-wise independent permutations locality sensitive hashing scheme and a locality-sensitive hashing.
